(19) United States
(12) Patent Application Publication
(10) Pub. No.: US 2004/0131539 A1
(43) Pub. Date: Jul. 8, 2004

(54) Formation of crystals containing hydrated aluminum oxide from caustic mother liquors

(76) Inventors: Detlef Kuboth, Duesseldorf (DE); Norbert Ingenhoven, Moenchengladbach (DE); Andreas Peist, Duesseldorf (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/469,983

(22) PCT Filed: Feb. 2, 2002
(86) PCT No.: PCT/EP02/01084

(30) Foreign Application Priority Data
Mar. 16, 2001 (DE) 101 13 294.8

(51) Int. Cl. C01F 7/02

(52) U.S. Cl. 423/629

(57) ABSTRACT

The invention relates to a method for the production of aluminium oxide hydrate containing crystals, whereby a liquid aluminium oxide hydrate phase is brought into contact with an auxiliary agent phase containing an organic auxiliary agent having at least one of the following properties:

(A) a cloud point within the range from 40 to 80° C.;

(B) a viscosity within the range from 100 to 1000 mPa's;

(C) an HLB value within the range from 1 to 19;

(D) an OH number within the range from 50 to 250 mgKOH/g;

(E) a solidification point within the range below 10° C.;

(F) a flashpoint according to DIN 51758 of >70° C.,

aluminium containing crystals, obtained in accordance with this method, a composition containing an aluminium hydrate phase as well as the use of aluminium hydrate containing crystals and phases.

The invention relates to a method for the production of aluminium hydrate containing crystals, aluminium hydrate containing crystals obtained by this method, a composition containing an aluminium hydrate phase as well as the use of aluminium hydrate containing crystals and phases.

The production of aluminium from bauxite today employs mainly the so-called Bayer method. For the recovery of aluminium with high purities in large scale operations it is desirable that the precursors for the aluminium production which originated from the Bayer method are also of high purity. The Bayer method uses naturally occurring raw material bauxites. These bauxites usually contain a number of impurities which, during the Bayer process, should be separated from the product to be processed to yield aluminium.

Important products from which aluminium is produced are aluminium hydrates, preferably aluminium trihydrate. This aluminium trihydrate is not only a precursor for the aluminium production but for a number of products based on aluminium oxide.

Besides the fact that the quality of the aforementioned products is impaired by these impurities, they also negatively affect the efficient processing of the aluminium hydrate crystals. For instance the crystal growth of aluminium hydrate crystals is impaired by the presence of oxalates to such an extent that only in the subsequent processing steps is it possible to obtain small sized crystals which even then can be processed only unsatisfactorily.

EP 286 034 discloses a method of reducing the percentage rate of small size aluminium trihydrate crystals by adding to the pregnant liquor an effective amount of two mutually soluble components (A) and (E), component (A) being a surfactant which will disperse component (B) in the pregnant liquor and component (B) being an oil.

This method has disadvantages since it involves using a two-component system which must be premixed prior to being employed in the Bayer process.

U.S. Pat. No. 4,578,255 discloses a Bayer process, wherein the purity of the products obtained from the Bayer process is achieved by adding water-soluble, vinylic cationic polymer with quaternary ammonium salts.

Also this method is in need of improvement in as far as a polymer is added in this process which must initially be synthesised from monomers at much cost and effort.

WO 99/30794 discloses a Bayer process, wherein the clarification, filtration and scale control of red mud containing liquors is accomplished by emulsion polymers, in particular high molecular weight poly acrylates, in the presence of surfactants, which for instance can be a C₁-C₁₀ linear or branched alkyl phenol ethoxylate.

Besides the fact that, just as in the preceding disclosure, an auxiliary agent is also used in this instance which must initially be polymerised from monomers, the processes concerned here are cleaning processes on the “red side” and not process steps in the production of aluminium oxide hydrate containing crystals which are undertaken on the “white side” of the Bayer process.

The object of the present invention in general is to overcome disadvantages arising from the prior art.

A further task set for the invention is to provide aluminium oxide hydrate crystals of high purity.

A further task set for the invention is to provide aluminium oxide hydrate crystals of a size which is particularly suited for processing of aluminium oxide and aluminium products.

The tasks set for the present invention are accomplished by a method for the production of aluminium oxide hydrate containing crystals, whereby a liquid aluminium oxide hydrate phase is brought into contact with an auxiliary agent phase containing an organic auxiliary agent having at least one of the following properties:

(A) a cloud point according to DIN 53917 within the range from 40 to 80, preferred from 50 to 70 and particularly preferred from 55 to 65° C.;

(B) a viscosity measured with a Brookfield spindle viscosimeter RV 2110 within the range from 100 to 1000, preferred from 200 to 500 and particularly preferred from 250 to 350 mPa s;

(C) an HLB value according to W. C. Griffin, J. Soc. Cosmet. Chem, 1, 311 (1950) within the range from 1 to 19, preferred from 5 to 15, particularly preferred from 8 to 13 and even more preferred from 10.7 to 11.1;

(D) an OH number within the range from 50 to 250, preferred from 70 to 150 and particularly preferred from 90 to 130 mg KOH/g;

(E) a solidification point of below 10, preferred below 0 and particularly preferred in the range from −2 to −20° C.,

(F) a flashpoint according to DIN 51758 of >70, preferred >100 and particularly preferred>150° C.

Further preferred embodiment forms in accordance with the invention are any combinations of the properties under A, B, C, D, E and F. Preferred combinations are A, B, C, D, AB, AC, AD, BC, AD, AE, AF, ABC, BCD, BCDE, BCDEF, ABD, ABDE, ABCD, ABCDE, ABCBEF where ABCDEF is particularly preferred and ABDE is even more preferred.

The contacting achieved by means of usual methods known to those skilled in the art, for instance by stirring, injecting or sprinkling of the auxiliary agent phase, where injection is the preferred method. It is further preferred that the contacting be achieved by stirring. The stirring is preferred to be at a speed within the range from 10 to 1000, preferred from 50 to 500 and particularly preferred from 70 to 200 rpm. Stirring speed and stirrer should preferably be selected such that the substances to be stirred are agitated and mixed, that however no gas is introduced into the mixture by bubble formation.

The auxiliary agent phase contains preferably at least 10% by weight, more preferred at least 50% by weight and particularly preferred at least 90% by weight, relative to the total auxiliary agent phase, of the organic auxiliary agent.

In accordance with the invention, a method is further preferred wherein the auxiliary agent is an adduct out of a C₇ to C₃₀ alkyl phenol and a C₂ to C₁₀ alkylene oxide. In this embodiment, a C₈ to C₂₀ alkyl phenol is preferred and a C₁₀ to C₁₅ alkyl phenol is particularly preferred. Further, a C₂ to C₇ alkylene oxide is preferred and a C₂ to C₃ alkylene oxide is particularly preferred. Among these ethylene oxide (EO) and propylene oxide (PO) are preferred, with ethylene oxide being particularly preferred. Further, it is preferred in accordance with the invention that the alkyl phenol and the alkylene oxide be used in a mole ratio of 1:1 to 1:20, preferred 1:4 to 1:15 and particularly preferred 1:5 to 1:10.

In a further embodiment of the method in accordance with the invention, it is preferred that the aluminium oxide hydrate phase be originated from the “white side” of the bauxite reprocessing in accordance with the Bayer method. It is preferred for the method in accordance with the invention using the Bayer process to follow the safety filtration, in particular through a Kelly filter or an activated carbon filter, preferably a Kelly filter.

It is further preferred in the method in accordance with the invention that the aluminium oxide hydrate phase has an aluminium oxide hydrate content of at least 10, preferred at least 50, and particularly preferred within the range of 55 to 95% by weight relative to the aluminium oxide hydrate phase, and shows at least one of the following properties:

(a) a STO₂ content within the range of max. 5, preferred max. 1 and particularly preferred of max. 0.1% by Weight relative to the aluminium oxide hydrate;

(b) a Fe₃O, content within the range of max. 5, preferred max. 1 and particularly preferred of max. 0.1% by weight relative to the aluminium oxide hydrate;

(c) a Na₂O content within the range of max. 10. preferred max. 5 and particularly preferred of max 0.5% by weight relative to the aluminium oxide hydrate;

(d) a water content at a temperature of 110° C. in the range of 5 to 45. preferred of 5 to 20 and particularly preferred of 5 to 12% relative to the aluminium oxide hydrate phase.

Further preferred embodiments in accordance with the invention are represented by any possible combination of the properties represented by the letters a, b, c and d. Preferred amongst these are a, b, c, d, ab, ac, ad, bc, ad, abc, bcd, abd, abcd, of which abcd is particularly preferred.

In accordance with a further embodiment of the method according to the invention it is preferred that the contacting be undertaken at a temperature of the aluminium oxide hydrate phase of at least 50, preferred at least 60 and particularly preferred at least 70 and even more preferred at least 80° C., where it is further preferred that the contacting be undertaken at a max. temperature of 150° C.

Furthermore one embodiment of the method in accordance with the invention is that the adduct is a compound with the general formula

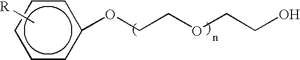

where

R=C₁ to C₉ alkyl, where the para position of R at the benzene ring is preferred,

n=mean 1 to 20, preferred 2 to 15 and particularly preferred 3 to 10.

It is further preferred in the method in accordance with the invention that the organic auxiliary agent be employed in a quantity within the range from 0.1 to 1000, preferred 1 to 500 and particularly preferred 2 to 250 ppm, relative to the aluminium oxide hydrate phase.

Further, the invention relates to an aluminium oxide hydrate containing crystal which is obtained in accordance with the method described above. It is preferred that the aluminium oxide hydrate containing crystal contain the previously defined organic auxiliary agent in a quantity in the range of 0.01 to 2, preferred 0.05 to 1 and particularly preferred 0.1 to 0.5 ppm, relative to the crystal. It is further preferred that the aluminium oxide hydrate containing crystal has an oxalate content of less than 100, preferred less than 50, particularly preferred less than 10 and even more preferred less than 1 ppm, relative to the crystal.

Further, the invention relates to a composition which contains an aluminium oxide hydrate phase and the organic auxiliary agent described above in a quantity in the range of 0.01 to 1000, preferred 1 to 300 and particularly preferred 5 to 250 ppm, relative to the composition.

Further, the invention relates to the use of the aluminium oxide hydrate containing crystal described above or the previously described composition for the recovery of aluminium or for the production of aluminium oxide products, preferably green bodies, ceramics of all kinds, fillers, preferably for cleaning and laundry products and tooth paste.

The invention is described in greater detail below by non limiting examples.

### EXAMPLES

General Instruction

In a 150 ml glass flask filled with 100 ml green liquour (taken from the Bayer process after the safety filtration undertaken by way of Kelly filtration and seeded with 12 g aluminium hydroxide with a particle size smaller than 45 μm “seed charge”) 5 ml of a 10% intrasol® NP6 emulsion (available from Messrs. Stockhausen GmbH & Co. KO, Germany) by way of a syringe. Subsequently the flask was held into a block thermostat with a magnetic stirrer at a temperature of 74° C. and a stirring speed of 100 rpm for 22 hours. After this, the crystals were separated by means of a vacuum filtration and washed with 500 ml of de-ionised water at a temperature of 80° C. The filter cake is dried in an oven at a temperature between 100 and 110° C. until weight constant is reached. The cake weight was determined on analytical laboratory scales. The results are shown in the following table:

| | Increase in the quantity of precipitated crystals | | | |
|---|---|---|---|---|
| | compared with a sample without addition of one of | | | |
| | the following auxiliary agents (Δ) | | | |
| | Dosage | Intrasol ® NP9 | Intrasol ® NP9 | |
| No. | [ppm] | (9 mol EO) | (6 mol EO) | FS + 7 mol EO |
| 1 | 25 | 0.89 | 0.57 | 0.17 |
| 2 | 50 | 0.98 | 1.03 | 0.18 |
| 3 | 100 | 1.20 | 1.33 | 0.18 |
| 4 | 200 | 1.98 | 1.12 | 0.17 |

FS = Fatty acid polyglycolester
EO = Ethylene oxide
Δ (g) = precipitation with auxiliary agent [g] − precipitation without auxiliary agent [g]

1. A method for the production of aluminium oxide hydrate containing crystals, whereby a liquid aluminium oxide hydrate phase is brought into contact with an auxiliary agent phase containing an organic auxiliary agent having at least one of the following properties:
(A) a cloud point within the range from 40 to 80° C.;
(B) a viscosity within the range from 100 to 1000 mPa's;
(C) an HLB value within the range from 1 to 19;
(D) an OH number within the range from 50 to 250 mgKOH/g;
(E) a solidification point within the range below 10° C.;
(F) a flashpoint according to DIN 51758 of >70° C.

2. The method in accordance with claim 2 wherein the auxiliary agent is an adduct out of a C₇ to C₃₀ alkyl phenol and a C₂ to C₁₀ alkylene oxide.

3. The method in accordance with claim 1 or 2, wherein the aluminium oxide hydrate phase originated from the “white side” of bauxite reprocessing according to the Bayer method.

4. The method in accordance with the preceding claims, wherein the aluminium oxide hydrate phase has an aluminium oxide hydrate content of at least 10% by weight, relative to the aluminium oxide hydrate phase, and shows at least one of the following properties:
(a) a SIO₂ content within the range of max. 5% by weight relative to the aluminium oxide hydrate;
(b) a Fe₂O₃ content within the range of max. 5% by weight relative to the aluminium oxide hydrate;
(c) a Na₂O content within the range of max. 10% by weight relative to the aluminium oxide hydrate:
(d) a water content at a temperature of 110° C. within the range of 5 to 45% relative to the aluminium oxide hydrate phase.

5. The method in accordance with any one of the preceding claims, wherein the contacting is undertaken at a temperature of the aluminium oxide hydrate phase of at least 50° C.

6. The method in accordance with any one of claims 2 to 5, wherein the adduct is a compound with the general formula 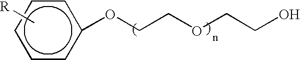
where
R=C₁ to C₉ alkyl,
n=mean 1 to 20.

7. The method in accordance with any one of the preceding claims, wherein the organic auxiliary agent is employed in a quantity within the range from 0.1 to 1000 ppm, relative to the aluminium oxide hydrate phase.

8. An aluminium oxide hydrate containing crystal which is obtained in accordance with the method described in the preceding claims.

9. The aluminium oxide hydrate-containing crystal containing the organic auxiliary agent defined in any one of the claims 1, 2 and 6 in a quantity within the range of 0.01 to 2 ppm, relative to the crystal.

10. The aluminium oxide hydrate containing crystal in accordance with claim 8 or 9 with an oxalate content of less than 100 ppm, relative to the crystal.

11. A composition, containing an aluminium oxide hydrate phase and the organic auxiliary agent defined in any one of claims 1, 2 and 6, in a quantity within the range of 0.01 to 1000 ppm, relative to the composition.

12. Use of the aluminium oxide hydrate containing crystal in accordance with any one of claims 8 to 10 or the composition according to claim 11 for the recovery of aluminium or the production of aluminium oxide products.
